(19) United States
(12) Patent Application Publication
(10) Pub. No.: US 2022/0383373 A1
(43) Pub. Date: Dec. 1, 2022

(54) METHOD, DEVICE, AND SYSTEM OF DIGITAL IDENTITY AUTHENTICATION

(71) Applicant: Forter Ltd, New York, NY (US)

(72) Inventors: Chen Amos Dolev, Givatayim (IL); Guy Zucker, Tel Aviv (IL); Iftah Gideoni, Kfar Vitkin (IL)

(21) Appl. No.: 17/825,656

(22) Filed: May 26, 2022

Related U.S. Application Data
(60) Provisional application No. 63/193,922, filed on May 27, 2021.

(51) Int. Cl. G06Q 30/06; G06N 7/00

(52) U.S. Cl. CPC G06Q 30/0609; G06N 7/005

(57) ABSTRACT

Verification systems and techniques are described. Verification systems may include at least one processor operatively connected to a memory configured to determine a probabilistic linkage, in real time, between a user initiating an event at a merchant and user identities associated with previous events through analysis executed on at least one of the user's attributes or attributes of the user identity; identify, based on the probabilistic link, a user identity of the user identities corresponding to the user initiating the event; and enhance authorization or authentication decisioning for the event in response to the probabilistic linkage to at least one of a bad or good actor persona, the authorization or authentication decisioning optionally including preventing the event in response to determining the user identity is associated with the bad actor persona or permitting the event in response to determining the user identity is associated with the good actor persona.

### CROSS-REFERENCE TO RELATED APPLICATIONS

This application claims the benefit under 35 U.S.C. § 119(e) of U.S. Provisional Patent Application Ser. No. 63/193,922, filed May 27, 2021 under Attorney Docket No. F0867.70001US00 and entitled “METHOD, DEVICE, AND SYSTEM OF DIGITAL IDENTITY AUTHENTICATION,” which is hereby incorporated by reference herein in its entirety.

### FIELD

The techniques described herein relate to determining a probabilistic linkage, in real time, between a purchaser initiating an on-line transaction and one or more user identities associated with previous transactions, and more particularly through analysis executed on at least one of the purchaser's attributes or attributes of the user identity, using, for example, machine learning techniques.

### BACKGROUND

Many systems and providers interact to execute modern commercial transactions. In a typical example, using a credit card can involve a merchant, a point of sale, a customer/card holder, a payment network, payment processor, issuing bank, etc. The various parties involved add layers of difficulty in processing the payment and in determining that a valid transaction is being requested. Some common participants in digital transaction execution include a service provider (or online service) who is an entity offering content, services, products or digital goods, and serving users, consumers or subscribers through online interactions. Service providers may operate in one or more of multiple verticals, under different business models, utilizing a variety of platforms and systems. Other participants include online fraud detection vendors (“OFDs”)—who provide services for ingesting user/server generated data and indicators, captured throughout an online service request/interaction, and provide trust/reputation decisions. For example, ingested data may include device, network, cyber, behavioral data and various other attributes that are fused to create a unique user “fingerprint,” that distinguishes a particular identity from all other digital identities. When an OFD is used to ingest data from one single service provider, the pool of unique identities managed by the OFD is limited to the users served by this one service provider, which can be referred to as a network of trust.

### SUMMARY

According to various aspects, systems and methods for verifying identity are provided. The systems and methods verify the identity of a user who is interacting, for example, with an online service provider, and the verification is executed to a desired trust level. According to some embodiments, the method leverages OFD decisions and information on previous trust assertion interactions. In various embodiments, identity verification can occur in at least two ways. In certain embodiments, for example, participating systems passively gather data that can be used to verify a user's claimed identity (e.g., behavioral information and/or biometrics, user activity patterns, purchasing patterns, amount of purchase, volume of purchase, type of purchase, etc.). In other embodiments, participating systems can require the user to go through an interactive, identity challenge, or active identification/verification functions. In some active verification settings, identity corroboration challenges can be executed that require an active response by the user, and in others can be done passively in the background (e.g., after installation of user verification software) with less impact on the user experience and requiring less interaction with the online service. According to one embodiment, the verification method can verify the user's identity by inheriting previous successful interactions within a network of trust, and then applying the inherited information to the relevant interaction. For example, the reputation built upon the various data points may be used across many entities or service providers to improve user experience by reduction of further friction and reduced burden of identity verification.

According to one embodiment, the identity verification executed by the system may be of well-established and onboarded identity (where the connection of the established identity to a single, real person is assured) or of an identity of which the reputation is built over time with less regard to the fidelity of the connection to a real person. Real world conditions enabled by the system provide for identity determinations that can adapt to situations where the level of onboarding is not always absolute. For example, the system can be configured to tailor identity determinations (e.g., with varying thresholds) in dependence on the probability and possible impact of wrong onboarding (e.g., where the system accepts the onboarded identity and in reality it is not the same person), on probability and possible impact of wrongly failed onboarding (e.g., where the system wrongly denies the onboarding of an identity) and on probability and impact of possible elevated friction and change to the user experience.

In further embodiments, the level of authentication may vary and need not always be absolute in all circumstances. In various embodiments, the system is configured to permit multiple levels and thresholds for determining authentication. For example, the system can be configured to varying levels and/or thresholds for authentication in dependence on the probability and possible impact of wrong authentication (e.g., where the system generates and assertion that authentication succeeded, and where in reality it is not the same person), on probability and possible impact of wrongly failed authentication (e.g., where the system wrongly determines that authentication could not be verified) and on probability and impact of possible elevated friction and change to the user experience (e.g., additional authentication burden results in abandoned transaction). In various embodiments, the method and level of authentication and the thresholds of decision may be set based on the scenarios above. In one example, the system provides elastic authentication based on the probability of wrong authentication determinations and/or the possible impact of the authentication decision in question. In various scenarios, the system can define and evaluate varying degrees of identity assurance.

According to an aspect of the present application a verification system is provided. The system may comprise at least one processor operatively connected to a memory, the at least one processor configured to determine a probabilistic linkage, in real time, between a user initiating an event at a merchant and one or more user identities associated with previous events through analysis executed on at least one of the user's attributes or attributes of the user identity; identify, based on the probabilistic link, a user identity of the one or more user identities corresponding to the user initiating the event; and enhance authorization or authentication decisioning for the event in response to the probabilistic linkage to at least one of a bad actor persona or a good actor persona, the authorization or authentication decisioning optionally including preventing the event in response to determining the user identity is associated with the bad actor persona or permitting the event in response to determining the user identity is associated with the good actor persona.

In some embodiments, the event is one of an on-line transaction, on-line account sign-up, or login to an existing account. In some embodiments, the event is a passage of a predetermined period of time after which a user session may expire. In some embodiments, the event is the user's attempt to access and/or edit sensitive account information. In some embodiments, the sensitive information comprises at least one or phone number, payment details, and/or shipping address. In some embodiments, the enhanced authorization comprises additional security measures. In some embodiments, in response to the user's successful navigation of additional security measures, the user identity is updated. In some embodiments, a type of enhanced authorization is based at least in part on attributes of the user identity and/or user attributes.

In some embodiments, a type of enhanced authorization is based at least in part on the merchant's preferences. In some embodiments, identifying the user identity comprises analyzing whether the probabilistic linkage between a user and a user identity of the one or more user identities exceeds a required level of confidence. In some embodiments, determining the probabilistic linkage comprises providing the at least one of the user's attributes or attributes of the user identity to a trained model to produce the probabilistic linkage. In some embodiments, the trained model is a machine learning (ML) model.

In some embodiments, determining the probabilistic linkage comprises applying a rule based system to at least one of the user's attributes or attributes of the user identity to produce the probabilistic linkage. In some embodiments, each of the one or more user identities includes one or more values indicating whether or not the user identity is likely associated with a bad actor persona or fraudulent activity or not. In some embodiments, the one or more values is determined at least in part based on prior reported fraudulent behavior. In some embodiments, the one or more values is determined at least in part based on characteristics independent of the user's actual identity or current registration information. In some embodiments, the one or more values is determined at least in part based on purchase history.

In some embodiments, the one or more values is determined at least in part based on physical events. In some embodiments, physical events may include in-store transactions. In some embodiments, the one or more values is determined at least in part based on a user identity's relation to other user identities of the one or more user identities. In some embodiments, preventing the event comprises cancelling the event or transmitting a command configured to cancel the event. In some embodiments, the user's attributes may comprise at least one of geographic location or position, information on the user's device, or information on communication links used in the event.

In some embodiments, the user's attributes may comprise at least one of prior knowledge of the user's attributes or prior knowledge of the user's reputation or past authentications and authentication preferences. In some embodiments, the user's attributes are based, at least in part, on information independent of registration or subscription of the user to the verification system. In some embodiments, the user's attributes may comprise at least one of prior knowledge of the user's other on-line activities and lack of consistency. In some embodiments, the one or more values may be updated over time based on subsequent transactions by a related user identity.

In some embodiments, the at least one processor is configured to evaluate a current event and determine an identity assurance threshold based on a probability of wrong authentication determinations and/or the possible impact of the authentication decision in question. In some embodiments, in response to a probability linkage that is low, the at least one processor is configured to enhance security measures, and wherein the system may obtain further attributes of the user using the enhanced security measures. In some embodiments, the at least one processor is configured to evaluate a required level of authentication and determine, based on prior adjustments, the minimum number of additional security measures that are required to meet threshold, and wherein the at least one processor is configured to validate the user once the minimum number of additional security measures are successfully navigated In some embodiments, in response to determining the user identity is associated with the good actor persona, the attributes are saved for future transactions such that the same user identity may be more easily authenticated at the merchant in the future. In some embodiments, in response to determining the user identity is associated with the good actor persona, the attributes are saved for future transactions, such that the same user identity may be more easily authenticated at a second merchant.

According to an aspect of the present application, at least one non-transitory computer readable storage medium storing processor-executable instructions is provided that, when executed by at least one processor, cause the at least one processor to perform a method for generating natural language text, the method comprising determining a probabilistic linkage, in real time, between a user initiating an event at a merchant and one or more user identities associated with previous events through analysis executed on at least one of the user's attributes or attributes of the user identity; identifying, based on the probabilistic link, a user identity of the one or more user identities corresponding to the user initiating the event; and enhancing authorization or authentication decisioning for the event in response to the probabilistic linkage to at least one of a bad actor persona or a good actor persona, the authorization or authentication decisioning optionally including preventing the event in response to determining the user identity is associated with the bad actor persona or permitting the event in response to determining the user identity is associated with the good actor persona.

According to an aspect of the present application, a method of generating natural language text is provided, the method comprising using at least one computer hardware processor to perform determining a probabilistic linkage, in real time, between a user initiating an event at a merchant and one or more user identities associated with previous events through analysis executed on at least one of the user's attributes or attributes of the user identity; identifying, based on the probabilistic link, a user identity of the one or more user identities corresponding to the user initiating the event; and enhancing authorization or authentication decisioning for the event in response to the probabilistic linkage to at least one of a bad actor persona or a good actor persona, the authorization or authentication decisioning optionally including preventing the event in response to determining the user identity is associated with the bad actor persona or permitting the event in response to determining the user identity is associated with the good actor persona. Still other aspects, embodiments, and advantages of these exemplary aspects and embodiments, are discussed in detail below. Any embodiment disclosed herein may be combined with any other embodiment in any manner consistent with at least one of the objects, aims, and needs disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described in connection with the embodiment may be included in at least one embodiment. The appearances of such terms herein are not necessarily all referring to the same embodiment. The accompanying drawings are included to provide illustration and a further understanding of the various aspects and embodiments, and are incorporated in and constitute a part of this specification. The drawings, together with the remainder of the specification, serve to explain principles and operations of the described and claimed aspects and embodiments.

### BRIEF DESCRIPTION OF THE FIGURES

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of a transaction execution environment 100 with transaction validation performed by system 110, according to one embodiment;

FIG. 2A is a block diagram of exemplary system 110 for performing validation, according to one embodiment;

FIG. 2B is a block diagram of a second exemplary system 110 for performing validation, according to one embodiment;

FIG. 2C is a block diagram of a third exemplary system 110 for performing validation, according to one embodiment;

FIG. 3 is an exemplary diagram of user identities and users, according to one embodiment;

FIG. 4A is an example of a transaction with probabilistic linkage to a good actor persona by system 110, according to one embodiment;

FIG. 4B is an example of a transaction with probabilistic linkage to a bad actor persona by system 110, according to one embodiment;

FIG. 5 is a flowchart of an exemplary process 500 for determining probabilistic linkage to a good or bad actor persona by system 110, according to one embodiment;

FIG. 6 is a flowchart representing how PCP is updated, according to one embodiment;

FIG. 7 is a flowchart of representative process for validating a transaction, according to one embodiment;

FIG. 8 is a block diagram of an example distributed system which can be improved according to the functions described herein, according to one embodiment;

FIG. 9 shows a flowchart of exemplary methods of updating the person chargeback probability (PCP) of a user identity, according to one embodiment;

FIG. 10 shows factors considered in determining a reputation of a user identity, according to one embodiment.

### DETAILED DESCRIPTION

Known in the transaction industry, is a maxim that increased complexity fuels purchase abandonment. It follows that improved security which results in increased complexity may ultimately be a disadvantage for normal processing of transactions due to abandoned transactions. Various aspects described herein, leverage existing systems and implementation to deliver improved identity verification, thus in various examples, eliminate any additional complexity for service providers/merchants and card issuing institutions while delivering improved security level and increased authorizations rates. Various embodiments of a verification system create and leverage a coalition of service providers, and their OFD providers or systems. Various embodiments include coalitions of OFDs that contribute information on prior trust assertion interactions.

According to various embodiments, the verification system provides a platform that allows a user who has been the subject of a previous trust assertion (e.g., by an OFD), regardless of the specific service provider being used, to have increased chance to proceed without going through an additional security challenge. For example, the system captures and analyzes previous trust assertions over a coalition of service providers and/or a coalition of OFD providers. According to one embodiment, the system trains and leverages intelligent models that generate trust assertions on current transactions based on prior trust assertions that may be executed by different OFD providers. In further embodiments, identity models can be constructed (e.g., trained and applied) that identify similarity between a current purchaser (or other entity desiring an electronic transaction or other electronic interaction requiring trust), and use the similarity between a current purchaser and prior purchasers to improve an assessment of risk performance. The various models can be configured to generate enhanced fraud insights to any customer, such as a bank or issuer of an electronic payment modality. In one example, the verification system can train and employ machine learning models that systematically define a probabilistic linking to identity based on prior trust assertions made within a service provider network.

Once an identity has been established to a required degree of probability, the system can provide an indication, for example, to an issuing bank that a transaction should proceed. According to one embodiment, the system is configured to establish the identity of an actor (e.g., purchaser) to a level of probability tailored to the situation (e.g., which is high enough), which can be derived from the desired level of trust. In some examples, the system enables multiple levels of probability which do not need to be the same for the assurance of connection to a real person and for the connection to a previously stored identity. Further embodiments allow system clients to provide their own criteria for a requisite level of trust, that the system can use and match for any online activity. In various embodiments, the probabilistic linking can use prior enhanced security feature (e.g., 3DS, etc.) operation to establish a high degree of confidence a purchaser's identity is valid for the current transaction/operation without using enhanced security interactions in the current transaction.

The inventors have realized that there is a need in the electronic transaction environment and marketplace to streamline transaction execution for users who have gone through an identity corroboration, and a need to limit transaction abandonment due to security implementation. Often, verification is a mandatory requirement by state regulation or business policies, but where verifying the identity of a user entails strong user authentication challenges, the resulting friction may result in increased abandonment rates. In other examples, any time that a transaction execution requires that the user go through additional interactive flows, that are not part of the sought-after service, the rate of abandonment goes up. From the service provider's point of view, provision of the service is conditioned on the user's successful completion of the corroboration challenge, and abandonment results in a loss. This is most troubling for valid and authorized transactions.

According to some aspects , the verification system yields improved confidence in identity verification and/or eliminates the multiplicity of user verification processes used with conventional implementation. In various embodiments, the verification system is configured to leverage prior trust assertions made in conducting previous transactions and can do so across a host of service providers where conventionally each service provider, OFD, and/or issuer isolated their security operations. For example, in many conventional on-line transactions, users are required to undergo separate authentication processes (e.g., at various points of the user journey) while interacting with the service providers. These separate authentications flows are done in isolation, introduce unnecessary user friction, and impair the overall customer experience. Furthermore, requiring multiple and separate authentication processes poses a security threat to individual users sharing personal data with multiple service providers. This threat also impacts service providers who are obligated by law or regulation (e.g., Strong Customer Authentication “SCA” requirements, etc.) to ensure that adequate data protection safeguards are in place. Furthermore, reaching the desired level of identity assurance as a result of the process with one service provider, enables friction-free service with other service providers. In further example, other service providers may require the same, different, lower, or greater levels of identity assurance, which may factor in the already reached assured identity.

It should be appreciated that while some examples described herein are with respect to transactions, the following methods and techniques may be used for any event, including where the event is one of an on-line transaction, on-line account sign-up, or login to an existing account, and may include in some examples, additional online activity. In some examples, the event may a passage of a predetermined period of time after which a user session may expire or may be the user's attempt to access and/or edit sensitive account information such as phone number, payment details, and/or shipping address.

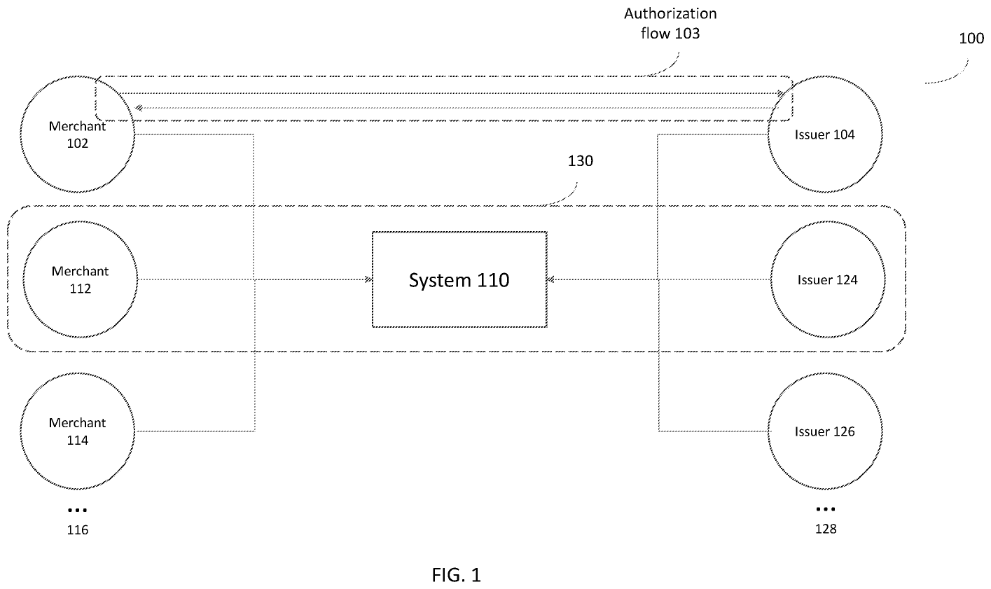

FIG. 1 is a block diagram of an exemplary transaction execution environment 100. According to one embodiment, an online transaction can be initiated by a purchaser at a merchant or merchant website (e.g., 102). Absent any validation of the transaction, the authorization flow (e.g., 103) goes directly from the merchant to an issuer (e.g., 104) associated with the purchaser's payment modality. Typically, an issuer can provide a purchaser a credit card or other payment modality used in online transactions. The issuer is the entity responsible for determining if a purchaser has available the funds to make a given purchase.

In modern transaction execution, various additional entities exist in between the merchant and the issuer and can provide security services to limit and/or reduce fraudulent transactions or other interactions. Returning to FIG. 1, the verification system 110 can operate as an intermediary between a merchant and an issuer. According to some embodiments, the verification system is configured to assess a risk level for performing a given transaction shown at one. In further embodiments, the verification system can provide enhanced fraud insights (e.g., at two) to any connected issuer (e.g., 104). The issuer may then make any decision on accepting the transaction based on the enhanced fraud insights provided.

In one example, the verification system leverages a wide history of prior transactions and trust assertions to assess the level of risk associated with the current transaction. In some embodiments, the verification system includes machine learning models that are configured to define a probabilistic linkage to a user identity and verify that a current purchaser is valid based on the probabilistic linkage. In various embodiments, the machine learning models are configured to evaluate information captured during the transaction, including, for example, information on a purchaser's device, aspects of the network connection performing the transaction, a person's reputation, a person's attributes, a person's behavioral characteristics, a person's preferences, and may even include the same characteristics of related people. In some embodiments, machine learning models can be trained to identify “related” people and use their characteristics to evaluate a current transaction.

As shown in FIG. 1, the verification system 110 serves as an intermediary in transactions executed by a number of merchants (e.g., 102, 112, 114—where the three dots at 116 indicate any number of additional merchants) and any number of issuers (e.g., 104, 124, 126—where the three dots at 128 indicate any number of additional issuers) associated with a payment modality presented by a purchaser.

According to some embodiments, the systems and methods disclosed enable reduced friction with the user and improves their experience, through leverage of previous trust, identity, and other data, by reaching a level of identity verification which is just enough for the required decision. Rather than implementing a security feature for every interaction, the system applies intelligence to determine what security features may be needed to achieve a desired level of trust, given all the information it already accumulated. For example, the system incorporates machine learning models (e.g., boosted regression trees, neural networks, outlier models, etc.) trained on various cyber data, including for example, behavioral data, past interaction data, etc. In various embodiments, the machine learning models are configured to match a current identity to previously known identities. In other embodiments, the machine learning models generate a probability of match to an identity and a level of trust attributable to the identity and/or the legitimacy of the initiator of the transaction.

In some embodiments, the system can include machine learning models that evaluate criteria not directly attributable to the matching of identities, but rather evaluate potential suspicious behavior. For example, the machine learning models can be trained to output an evaluation that serves as a proxy for a bad/good actor and/or bad/good intent in evaluated criteria. In further example, the system uses the machine learning model to determine the propensity for the initiator of the transaction for evasive behavior or attempts to hide or assume a false identity.

In various embodiments, most of the data is used for matching an identity of an actor (e.g., purchaser) to previous known identities. Further data elements include several pieces of information that do not contribute directly to the matching of identities, but point to suspicious behavior, and thus the data used to train some models may serve as a proxy to the propensity of the person interacting with the system for evasive behavior or an attempt to hide or assume a false identity

In still other embodiments, the system can include inclusion and exclusion lists. The inclusion/exclusion lists can improve processing for edge cases where phenomena that are not well represented in a training set may be materially important to a system based evaluation. According to one embodiment, the system is configured to identify where people try to hide or make a false representation of identity. In some embodiments, the system can be configured to determine circumstances indicative of an intelligent adversary, and where past behavior may not be a good enough representative of future behavior. In some examples, the system can be configured to tune thresholds associated with a confidence level for establishing identity, increase/decrease the required level of confidence based on indicia of good/bad intent, and/or machine learning outputs that determine a similarity to good/bad intent/actors.

In further embodiments, the system is configured to analyze, in real time, an on-line transaction based on the purchaser's attributes, including at least one of: prior knowledge of the related user identities' behaviors, preferences, and/or prior knowledge of related user identities' behaviors and preferences. For example, the system can evaluate behavior information which may include any one or more or any combination of attributes relating to the non-common (that is, unique to some differentiating degree) way a person presents themselves online. In some embodiments, the system analyzes behavior information and attributes that reflect the rate of purchases, the amount of time an actor stays on each page in a service provider's website with combination with characteristics of the mouse movements on each page, the payment methods they normally use, the speed of typing of credit card primary account number (“PAN”) and the grouping of typing (e.g., each four digits and pause, or first 6 [the BIN] then the middle 6, then last 4.). In further example, the system can be configured to analyze preferences associated with on-line transactions or behaviors. In various embodiments, preference may relate to choices the person in question makes during their interaction online. Such preferences may include, for example, choices of alternative payment method when the first failed, choice of authentication method where challenged, choice of shipment methods, etc. and may be based, among other factors, on their residence, currency and language combinations.

In still other embodiments, the system can analyze prior knowledge of related people to provide additional evidence toward the establishment of the probabilistic assurance of identity. For example, the system can be configured to determine at least a projection of legitimacy level and/or the rarity of behavior of particular people among their peers. In one embodiment, the system determines a projection of legitimacy level, that uses rare cases for insights into identity. Rare are the cases where legitimate people or personas are found to be related to fraudulent people and vice versa. For example, a close relation to an already proven legit entity, decreases the probability that the person tries to hide or forge their identity, and increases the system's confidence/assurance in the established identity. In another embodiment, the system can use the rarity of behavior of particular individuals among their peers to evaluate identity. In one example, knowledge of the common email user patterns in America indicates that very few of them are using digits-only usernames (comparing, for example, to China, where this is common). Given this knowledge, the system can assert that the probability of two personas that use digits only username in America to be the same person is higher than if these two personas were in China.

In some embodiments, the system is configured to enhance the consumer experience under identity verification constraints using real time analysis of the consumer's attributes. For example, the system can evaluate geographic information, data on a person's device, data on a connection, etc. In one example, the system analyzes a path of physical locations across a series of interactions that occur in transaction processing. In another example, the system can evaluate physical locations of proxies that participate in transaction execution and/or are part of a communication pathway. In other embodiments, a-priori knowledge of reputation can be part of an evaluation of trustworthiness. Similarity between circumstances of a current transaction can be used to develop contextual understanding of a given transaction, which is used by the system to establish a threshold level of assurance that the system will require for approving a current transaction.

In some embodiments, the verification system can use intelligent routing operations to increase a likelihood of the user successfully completing authentication and/or authorization to a user identity and/or to meet a desired level of verification and/or increasing the likelihood of authentication method to conduct effective authentication (e.g. not send email verification if likely email is compromised). In some embodiments, the system is configured to manage the likelihood of a successful online operation, for example, based on user history, likelihood of the user to complete the authentication method, likelihood of authentication method to conduct effective authentication (e.g. not send email verification if likely email is compromised).

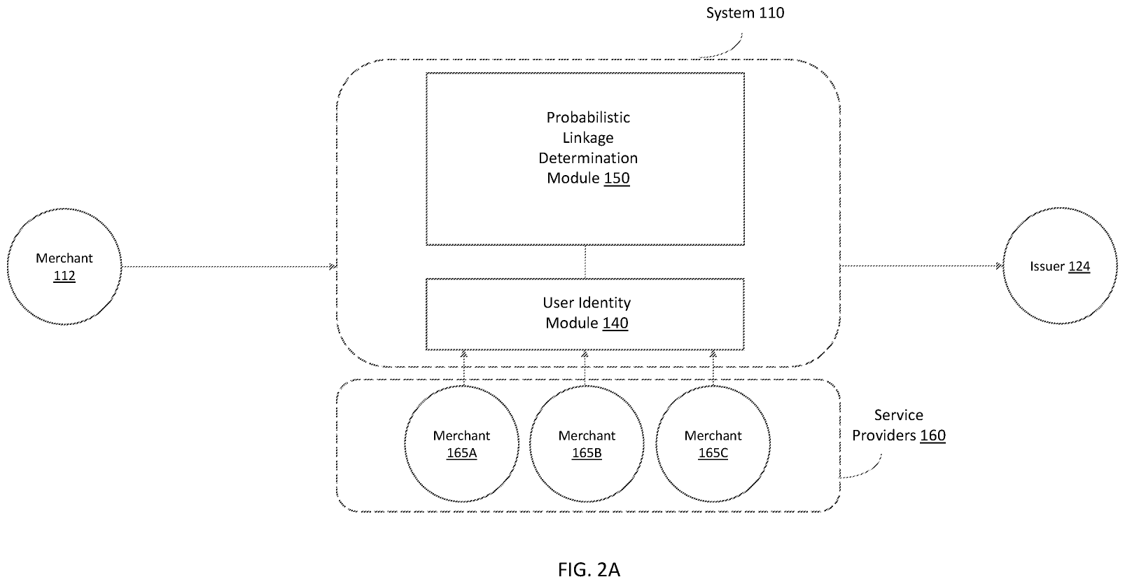

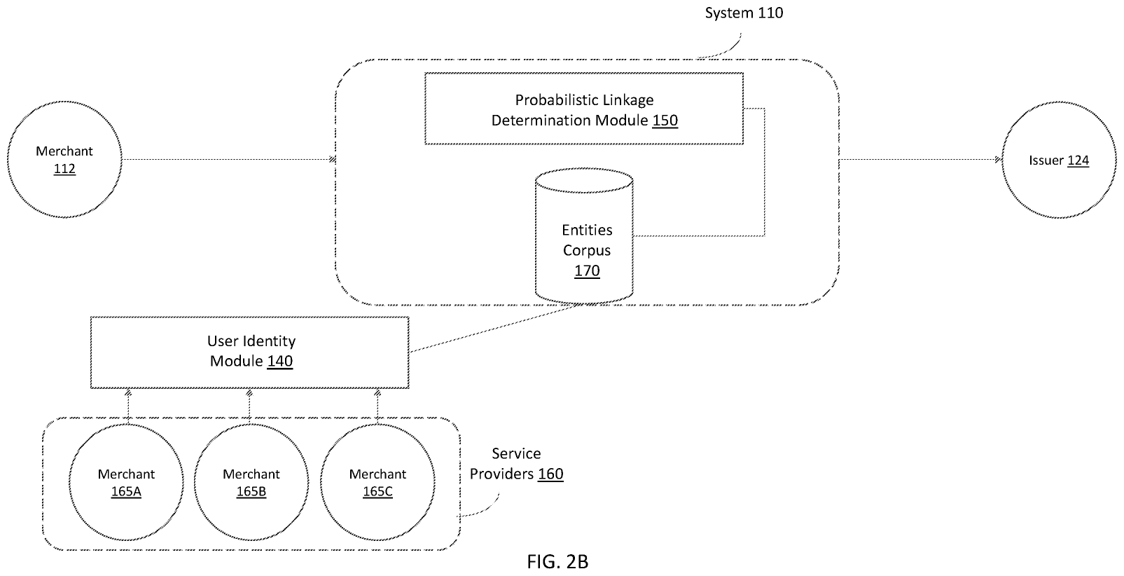

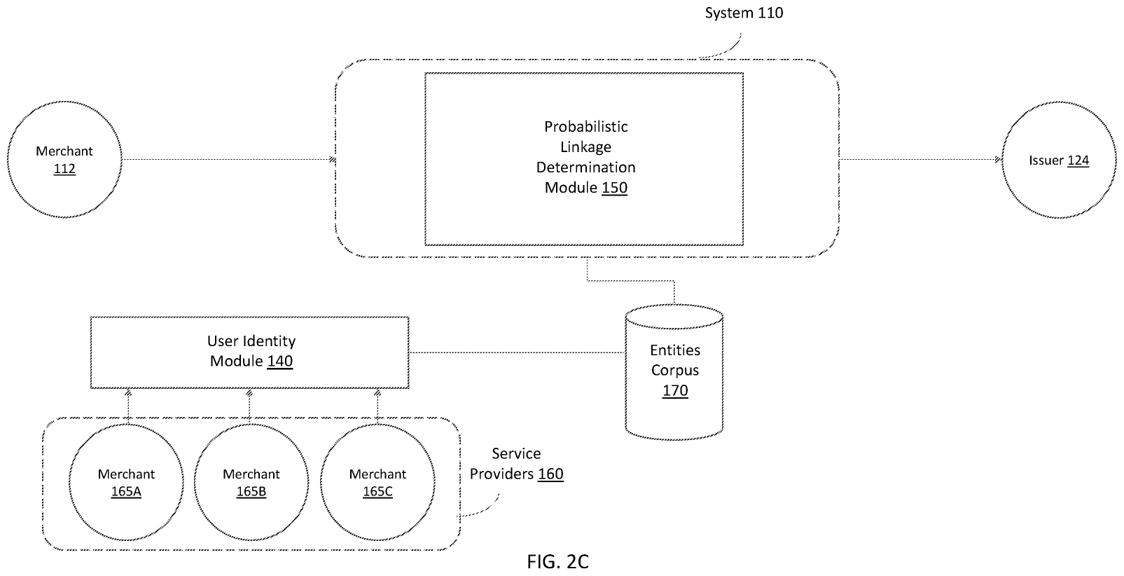

FIG. 2A is a block diagram of exemplary system 110 for performing validation, according to one embodiment. The system 110 is configured to obtain data regarding an online transaction made at merchant or merchant website 112. The data may be obtained, for example, by requesting and pulling data from the merchant 112 or by being provided data by the merchant 112. The data or aspects of the data may be provided via a communication network (not shown), such as the Internet or any other suitable wired or wireless network, as aspects of the technology described herein are not limited in this respect. The data may comprise information including the transaction amount, an email of the user attempting to make the transaction, the name of the user attempting to make the transaction, the billing or shipping addresses listed for the transaction, and/or the like. The data may be organized in list, array or table form and may be structured in one or more files.

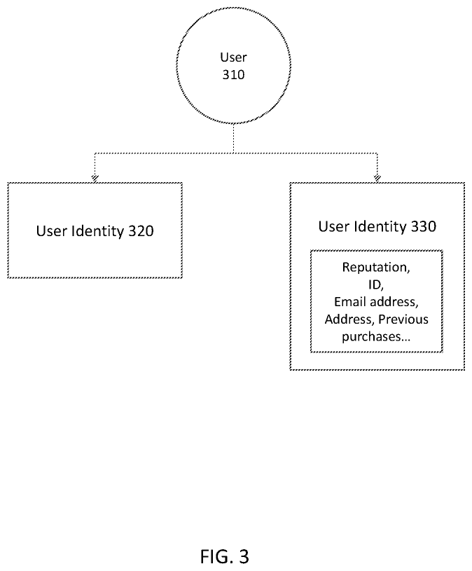

The user identity module 140 of system 110 may also be configured to generate or obtain data regarding user identities, where each user identity represents a single transaction or a group of transactions having similar or equivalent identifiers/attributes (e.g., past transaction amount, names, devices, etc. According to some embodiments, the user identity module 140 may take in data from multiple merchants such as 165A-C regarding a large number of transactions. The user identity module may use the data from service providers 160 such as merchants 165A-C and generate user identities for users making online transactions. Each user identity may have one or more identifiers and attributes defining it, as well as a probability associated with it, showing the probability the user identity is a fraudster or not. In some examples, each user identity may have a reputation, which may indicate the likelihood the user will file a chargeback or label, indicating that the user identity is one associated with a “good persona”—unlikely to be a fraudster—and one associated with a “bad persona”—likely to be a fraudster. User identities are described further in reference with FIG. 3. As described above, the data or aspects of the data may be provided in any suitable way, and in any suitable form.

The system 110 may use at least part of the data regarding the transaction from the merchant 112 and may determine a probabilistic linkage between the current transaction and one or more user identities from user identity module 140 using the probabilistic linkage determination module 150. The probabilistic linkage determination module 150 may determine the probabilistic linkage in various ways, including by comparing one or more characteristics of the current transaction against those of the one or more user identities.

In some examples, the probabilistic linkage determination module may execute one or more trained models to determine the probabilistic linkage. In some examples, one or multiple characteristics of the current transaction at merchant 112 may be input to the one or more trained models to determine the probabilistic linkage. According to some embodiments, the one or more trained models may use a distance calculated using values of attributes of a known “good actor persona” of the user and the values of attributes of the current transaction as input. In some examples, the probabilistic linkage determination module may use one or more rule based systems to determine the probabilistic linkage.

In some examples, the probabilistic linkage determination module may use one or more trained models in combination with a rule based system to determine a probabilistic linkage. For example, the probabilistic linkage module may obtain one or more user identities (e.g., from the entities corpus) that are similar or probabilistically linked to the current transaction based on attributes of both. The probabilistic linkage module may then score each of the matches (i.e., user identities that are obtained) based on the rarity or odds of certain attributes of the current transaction and/or attributes of the matches). For example, a transaction by a user and user identities from a same countryside house show an increase in the likelihood they are found to be legitimate, as opposed to a user making a transaction with the same login information as a user identity whose shipping address is a different country. The module may then adjust scores based on dependencies between different queries. For example, two unrelated people having shipping addresses to the same city have a higher chance of sharing the same interne service provider. As another example two unrelated people sharing the same last name are likely from the same country. A trained model (e.g., ML model) may be used to boost the scores based on the detection of certain activities, such as suspicious behavior by a user identity with similar attributes. For example, a regression model, outlier model, or classifier can be trained on characteristics of prior transactions to return a probability the transactions/actors are linked to valid identities.

The system 110 may then identify, based on the probabilistic link, a user identity of the one or more user identities corresponding to the purchaser initiating the on-line transaction. If the linkage is to a user identity with a “bad actor persona” or a user identity associated with fraudulent behavior, the system may alert the issuer and/or merchant to prevent the online transaction. For example, the system may analyze one or more attributes of the current transaction and yield a probability that the current transaction is linked to a bad actor persona. If the probability is sufficient (e.g., a threshold is exceeded or met), the transaction may be prevented and the data regarding the current transaction may be saved or used to update the user identity. If the linkage is to a user identity with a “good actor persona” or a user identity associated with validated or non-fraudulent behavior, the system may allow the online transaction to proceed. According to some embodiments, if the attributes of the transaction are sufficiently different from a “good actor persona,” the system may identify that the transaction is likely a fraudulent transaction as well.

According to some embodiments, in response to determining the user identity is associated with the good actor persona, the attributes of the linked user identity and/or the current transaction may be saved for future transactions such that the same user identity may be more easily authenticated at the merchant in the future. For example, once a user's transaction is probabilistically linked to a good persona, the merchant may allow continuous session/login such that the user's session is extended without the need to log in again even after long periods of inactivity.

According to some embodiments, in response to determining the user identity is associated with the good actor persona, the attributes of the linked user identity and/or the current transaction may be saved for future transactions, such that the same user identity may be more easily authenticated at a second merchant. For example, once a user's transaction has been linked to a good actor persona at a first merchant A, the system may use this information to allow access or transactions at a second merchant B.

Part of the data that is used may include attributes of the transaction that would indicate a fraudster's takeover of the user's account. For example, the data may include whether or not the purchaser is using a device that is typically used by good actor personas of the user (e.g., as opposed to a fraudulent user posing as the user), whether a new/different shipping address is used, whether the cost of the transaction is typical, or varies greatly from typical purchases by the user. The data may also include IP address, such as whether the login was through a different IP address than typical good actor personas of the user. Another thing the system may consider is whether attributes of the current transaction align or are sufficiently similar to attributes of transactions that occurred across many different users. For example, fraudsters are more likely to attempt multiple fraudulent transactions, rather than a single transaction, and so similar information across multiple users can indicate fraudulent purchases.

FIG. 2B is a block diagram of a second exemplary system 110 for performing validation, according to one embodiment. According to some embodiments, the user identity module may be provided on a separate device than system 110 but may be communicatively coupled to system 110. The system 110 may instead include an entities corpus 170 configured to store data on the user identities once the user identity module generates one or more user identities. The entities corpus may obtain data periodically, continuously, or when the user identity modules updates or generates a new user identity. In further example, the data may be updated from other OFD providers, security decisions, etc., obtain indirectly from other transaction records, among other options.

FIG. 2C is a block diagram of a third exemplary system 110 for performing validation, according to one embodiment. According to some embodiments, the entities corpus 170 may be provided on a separate device than system 110, but the system 110 may be configured to obtain data through any communication method suitable in order to obtain information on user identities. For example, the system 110 may obtain the data by requesting all or some of the user identity data.

FIG. 3 is an exemplary diagram of user identities 320 and 330 representing transactions attempting to purchase as user 310, according to one embodiment. As described herein, the user identity module 140 may also be configured to generate or obtain data regarding user identities 320 and 330 and each user identity may represent a single transaction or a group of transactions having similar or equivalent identifiers/attributes (e.g., past transaction amount, names, devices, etc.).

The user identity module 140 may develop these user identities over time as it takes in data from multiple merchants (e.g., merchants 165A-C) regarding a large number of transactions. A user identity is created when data regarding a new transaction is provided (e.g., by merchants 165A-C, service providers 160) and the attributes of the new transaction are sufficiently different from any existing user identities. For example, if a number of attributes or more (e.g., 3, 5, 10) are different from any existing user identity. In some examples, a new user identity may be created if certain attributes are different than those of existing user identities (e.g., name, address, etc.). A user identity may be updated when data regarding a new transaction is provided and the attributes of the new transaction are sufficiently similar to the user identity. For example, if a number of attributes match (e.g., 3 identifiers) such as cookie information, IP address, session information, email, account information, addresses, etc. Attributes may also include instances of reported fraud, for example, the user identity may include information including previous chargebacks, fraud alerts and victim confirmed fraud. In some examples, attributes include purchase history and entity relations where one entity's reputation is affected by another's (e.g., Entity A (containing the fraudster's first transaction which was approved) that is seen by Entity B (another transaction submitted by the same fraudster later on, manipulating a different victim's identity, and was declined)).

User identities may also be updated based on physical events. For example, user identities may be updated based on in-store transactions using a credit card by associating the buyer with the store locations, as well as other information that can help probabilistically confirm the transaction is legitimate/suspicious.

Each user identity may include one or more identifiers as well as a label that may indicate that the user identity likely belongs to a bad or good actor persona (e.g., fraudulent or legitimate purchaser). In some examples, alternative to, or in addition to, a label, the user identity may include a probability that it is associated with a fraudulent purchaser or not. User identities may include any suitable identifiers including, but not limited to, addresses (shipping, billing, IP), emails, device information, names, phone information, phone number, merchant website, visited sites, payment methods, cart items, previous purchases, etc. The label of a user identity may be updated as well. Each user identity may also include an attribute such as reputation, regarding whether or not the user is likely to file a chargeback, for example.

Each user should ideally have a single “good actor persona” user identity, however, when the system cannot sufficiently link a transaction to a single user identity, a new user identity may be created under the same user. Over time, if a user has not reported a transaction associated with a user identity to be fraudulent, the user identity may be merged or incorporated with an existing user identity associated with a good actor persona.

The user identity may also have one or more values such as numeric values, indicating probability of fraud or representing the risk for specific type of malicious behaviors, as well as descriptive values representing reputation as good or bad, as described herein.

In further embodiments, probabilistic linkage can be used to selective trigger or not elastic authentication gateways. Additional security measures during transaction processing can be referred to as friction, as they slow and sometime even result in valid transaction not being completed. In various embodiments. the system evaluates a user identity to determine a probability of match to an actor (e.g., and its label as a good or bad actor). The linkage can then be used to trigger enhance security measures (e.g., 3DS, etc.) during processing, for example, to resolve a low probability match to a good actor or a low probability match to a bad actor. In further example, additional security measures can be triggered to increase the probability of match to persona. Once the user successfully navigates the enhanced security, subsequent identity matching can leverage the security success in later determinations of the probable match to the user identity. In further example, the prior security success can be used by the system to ensure further additional security measures are not invoked in subsequent transactions or in later steps of processing, thus preventing redundant friction. In still other embodiments, the system is configured to tailor analysis of probability of a match to achieve any threshold level with least resources/analysis necessary. For example, the system may evaluate a required level of authentication and determine, based on prior adjustments, the minimum number of additional security measures that are required to meet threshold, and wherein the at least one processor is configured to validate the user once the minimum number of additional security measures are successfully navigated. In such embodiment, the system provides the most efficient approach for determining a requisite (e.g., processor specified, system specified, etc.—which can be dynamic) level of identity assurance.

In some embodiments, once a user successfully navigates additional security measures, the user identity is updated, e.g., to reflect that the user is more likely not a bad actor. In some examples, the type of enhanced authorization is based at least in part on attributes of the user identity and/or user attributes. For example, if user identities linked to a user show that an email of the user may have been compromised, the system may recommend authentication via SMS rather than confirmation email. Or if the user identities associated with bad personas show that a fraudulent user is not a sophisticated bad actor, the system may recommend a simpler authentication such as using a security question.

In some examples, the type of enhanced authorization used is based at least in part on the merchant's preferences. According to some embodiments, merchants may also have policies/regulations they want to adhere to and so may set certain thresholds for user authentication. In some examples, the merchant may require more difficult authentication requirements for a user that has crossed a threshold of activity. For example, a merchant may typically not require verifying a phone number at sign up of an account, but may require a user add one once a threshold of $2000 has been spent. Another example may include, a user who is attempting to hide their location and is based in France should have multi-factor authentication (MFA) triggered.

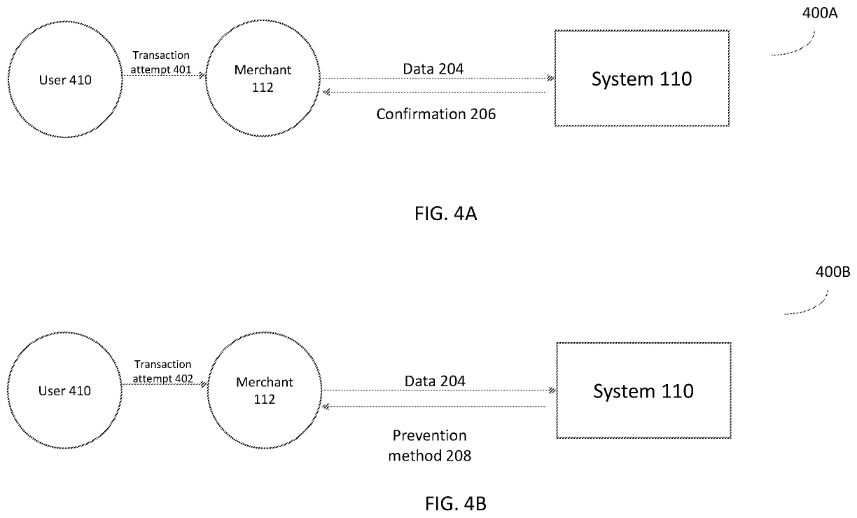

FIG. 4A is an example of a transaction 400A with probabilistic linkage to a good actor persona by system 110, according to one embodiment. As described herein, When a user 410 makes a transaction 401, the merchant may send to system 110, information regarding the transaction in order to validate the transaction. For example, the merchant may send information regarding the user's account, payment information, the billing or shipping address, the items being purchased, the total cost of the purchase, browser information, cookie information, etc. The system then determines, using the probabilistic linkage determination module, whether or not the transaction is likely being performed by a fraudulent user or not. In response to determining the purchase and information regarding the transaction is not probabilistically linked to a bad actor persona, or that it is probabilistically linked to a good actor, the system 110 may send confirmation 206.

FIG. 4B is an example of a transaction 400B with probabilistic linkage to a bad actor persona by system 110, according to one embodiment. When a user 410 makes a transaction 402, the merchant may send to system 110, information regarding the transaction in order to validate the transaction. The system then determines, using the probabilistic linkage determination module, whether or not the transaction is likely being performed by a fraudulent user or not. In response to determining the purchase and information regarding the transaction is probabilistically linked to a bad actor persona, or that it is not probabilistically linked to a good actor, the system 110 may send a prevention method 208. For example, the prevention method 208 may be an instruction or command to prevent the transaction, or may be a recommendation/instruction for additional validation at the merchant (e.g., asking the purchaser to perform certain tasks such as two step verification, asking the purchaser security questions, etc.). Additionally, the system may store or transmit this information in order to update user identities.

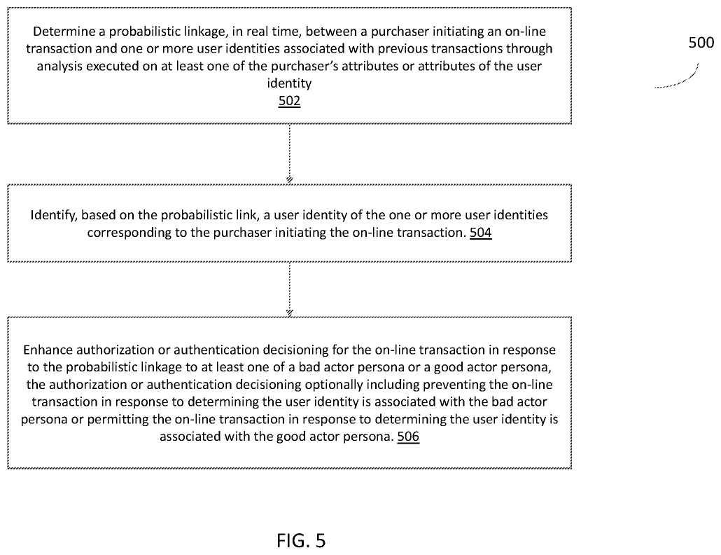

FIG. 5 is a flowchart of an exemplary process 500 for determining probabilistic linkage to a good or bad actor persona by system 110, according to one embodiment. Process 500 may be performed using any suitable computing device(s). For example, in some embodiments, the system 110 may perform the illustrative process 500 of FIG. 5. In some examples, the process may be performed by probabilistic linkage determination module 150, instead.

At act 502, the computing device(s) may determine a probabilistic linkage, in real time, between a purchaser initiating an on-line transaction and one or more user identities associated with previous transactions through analysis executed on at least one of the purchaser's attributes or attributes of the user identity. For example, the computing device may execute one or more trained model using attributes of the on-line transaction as input to determine a probabilistic linkage between the purchaser and the user identities. The trained model may be a machine learning model (e.g., convolutional neural network, recurrent neural network, etc.). According to some embodiments, the computing device may execute one or more trained models using a distance calculated using values of attributes of a known “good actor persona” of the user and the values of attributes of the current transaction.

At act 504, the computing device(s) may identify, based on the probabilistic link, a user identity of the one or more user identities corresponding to the purchaser initiating the on-line transaction. For example, the user identity may be one having the most similar or equivalent attributes as the current transaction. In one example, based on an output of the trained model, the computing device(s) may determine the user identity that the transaction is most closely associated to the transaction (e.g., highest probability).

At act 506, the computing device(s) may enhance authorization or authentication decisioning for the on-line transaction in response to the probabilistic linkage to at least one of a bad actor persona or a good actor persona. For example, the authorization or authentication decisioning optionally includes preventing the on-line transaction in response to determining the user identity is associated with the bad actor persona or permitting the on-line transaction in response to determining the user identity is associated with the good actor persona. The computing device(s) may prevent the transaction itself, or may be configured to transmit a command or warning for the issuer or merchant to prevent the transaction.

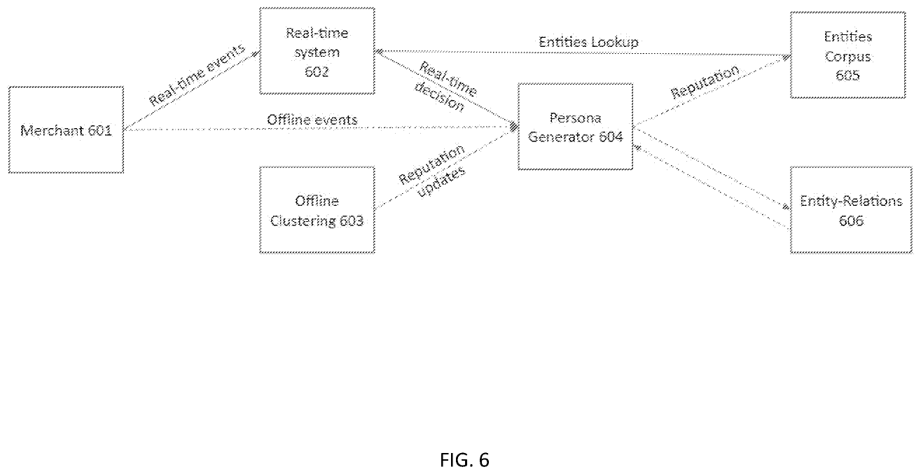

FIG. 6 is a flowchart representing an exemplary flow 600 for how an entities corpus may be used by the system 110, according to one embodiment. The flowchart also shows how the system 110 may update the reputation of entities of the entities corpus based on an output of the system 110, represented here as Real-time system 602. In FIG. 6 a transaction is attempted by a purchaser at a merchant 601. The transaction information is assessed using techniques described herein to determine a probabilistic linkage to a user identity at Real-time system 602, for example, by obtaining data from the entities corpus 605, e.g., related to the transaction. Based on the probabilistic linkage, a decision may be made to either prevent the transaction, permit the transaction, enhance security measures, etc. The probabilistic linkage of Real-time system 602 of the transaction to a user identity will trigger actions to affect the purchaser, such as preventing/permitting the transaction and/or the like. The Persona Generator 604 may subsequently be notified with the probabilistic linkage to a user identity with a good or bad actor persona in order to update the Entities Corpus. A payload may be generated in step 604, where a payload is used to collect past data regarding the user identity, and will hold its aggregated reputation,. The payload may be updated in various offline flows, one of which is the Offline Clustering in step 603, marking post-factum fraudulent attempts as being related to the same bad actor. The payload may be also used to determine relationships between the user identity corresponding to the transaction and other user identities in step 606, and the payloads of those related entities may in return affect the user's payload.

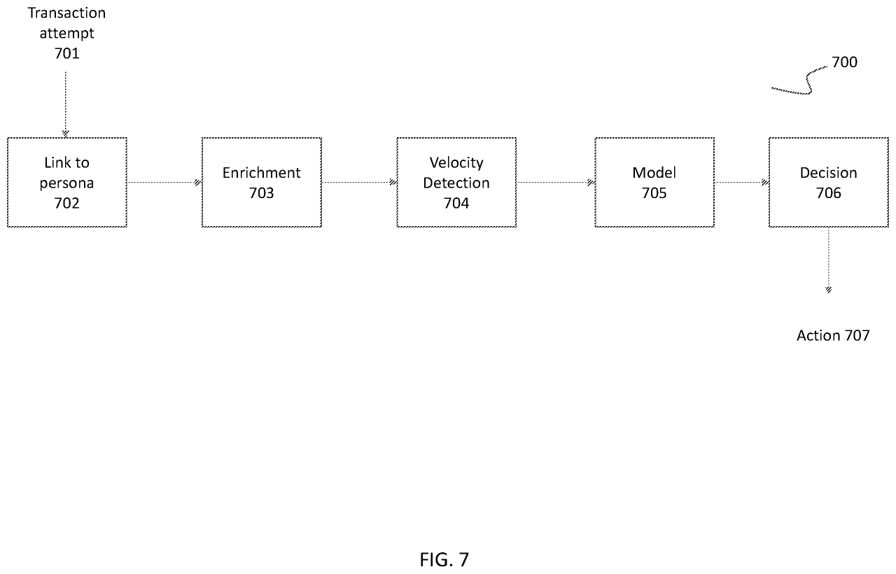

FIG. 7 is a flowchart of representative process 700 for validating a transaction, according to one embodiment. At step 701, the purchaser attempts to make a transaction at a merchant. (e.g., merchant website, storefront, etc.) At step 702, using the data regarding the transaction, the attributes may be determined, which may be determined based on information regarding the current transaction. During the enrichment process at step 703, the information provided in the data regarding the transaction may be enriched. For example, the data may be enriched by enhancing existing information by supplementing missing or incomplete data. In step 704, using the enriched data, the system may obtain user entities that are relevant to the current transaction, including user identities that are probabilistically linked. For example, based on a transaction, the system may recognize that a user under the login information “Steve” with account number “#324” is attempting to make a transaction. The system may find a user identity that is known to have attributes associated with legitimate transaction of “Steve” with account number “#324”. The data of the detected user identities may then be input into a trained model (e.g., machine learning model) at step 705. The output of the model may then be used to make a decision in step 706 as to whether or not the transaction is probabilistically linked to a bad actor persona or a good actor persona. If the transaction is probabilistically linked to a bad actor persona, the next step 707 may include an action to enhance security protocols and/or require further authentication and/or may prevent the transaction. If the transaction is probabilistically linked to a good actor persona, the next step 707 may include an action permitting the transaction, or communication to downstream processors/processes that the transaction is probabilistically linked to a good actor.

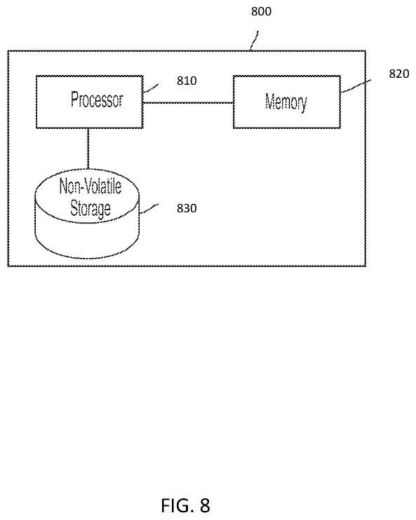

Additionally, an illustrative implementation of a special purpose computer system 800 that may be used in connection with any of the embodiments, and improved by execution of the disclosure (e.g., functions, processes, algorithms, etc.) provided herein is shown in FIG. 8. The computer system 800 may include one or more processors 810 and one or more articles of manufacture that comprise non-transitory computer-readable storage media (e.g., memory 820 and one or more non-volatile storage media 830). The processor 810 may control writing data to and reading data from the memory 820 and the non-volatile storage device 830 in any suitable manner. To perform any of the functionality described herein (e.g., transaction evaluation, probability analysis, re-routing transaction pathways, re-submitting transactions, etc.), the processor 810 may execute one or more processor-executable instructions stored in one or more non-transitory computer-readable storage media (e.g., the memory 6), which may serve as non-transitory computer-readable storage media storing processor-executable instructions for execution by the processor 810.

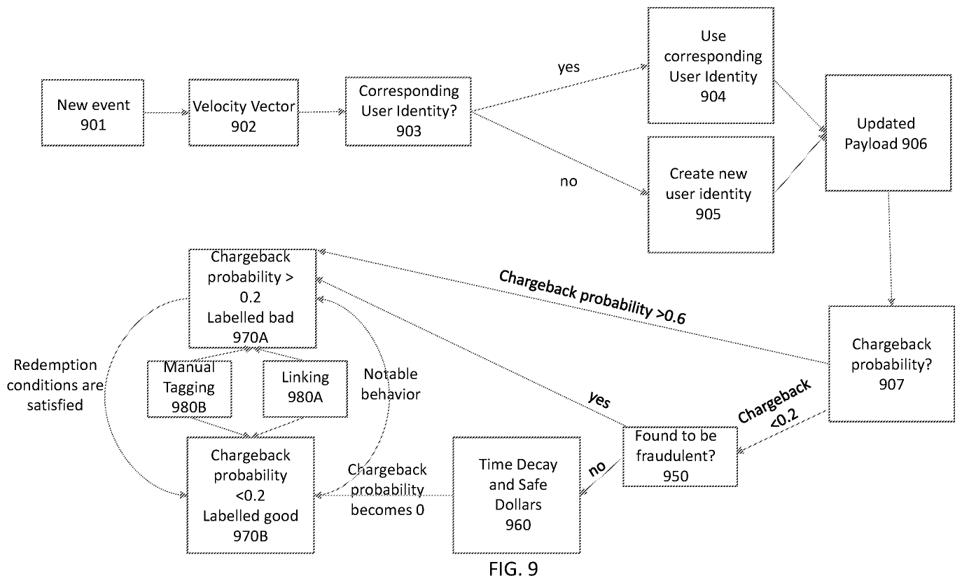

FIG. 9 shows a flowchart of exemplary methods of updating the person chargeback probability (PCP) of a user identity. Whenever a new event occurs at 901, such as a log-in, new online or in person transaction occurs, the process 900 may begin. The velocity vector may be a vector that is used to obtain the relevant user identities from the user identity module or corpus of entities at step 902. If a corresponding user identity is found in step 903, the corresponding user identity may be used (e.g., 904) otherwise a new user identity may be created as in step 905. The user identity is then updated with information regarding the new event.

The chargeback probability is detected at step 907. If the chargeback probability is less than 0.2 or 20%, and the user identity is found to be not fraudulent at step 950, after a threshold of time where fraud is not detected and/or a threshold amount of “safe” money (e.g., money that cannot be filed as a chargeback) is spent, the user identity is labeled to be good (e.g., not likely fraudulent). If the chargeback probability is less than 20% (i.e., 0.2) but the user identity is found to be likely fraudulent, the user identity is labeled to be bad. If the chargeback probability is higher than 0.6, then the user identity is labelled bad.

At any point, a user identity with reputation as bad may have their reputation relabeled as good and a user identity with reputation as good may have their reputation relabeled as bad if a manual inspection of the user identity determines that it the user identity is good (e.g., not associated with fraud) or bad (e.g., associated with fraud and chargebacks) as at step 980B. Similarly, if the user identity is merged with another user identity, the reputation of the user identity may change at any point based on the identity it is being merged with as at step 980A.

User identities that were labeled to be good may be relabeled to be bad if any notable behavior occurs. On the other hand, user identities that have a reputation as bad (e.g., more likely to be fraudulent and/or file chargebacks) may be redeemed by meeting one or more redemption conditions. Redemption conditions may include, for example, user identities that were labelled as being bad due to being related to other user identities that were labelled as bad. If the other user identities are redeemed to be labelled as good, the related user identity may also be redeemed. In some examples, a redemption condition may include user identities that were labelled as bad previously, but are newly connected/related to user identities that are labelled as being good. Another redemption condition may include that the user identity is not connected or linked to other user identities. This could indicate that the user identity is indeed good.

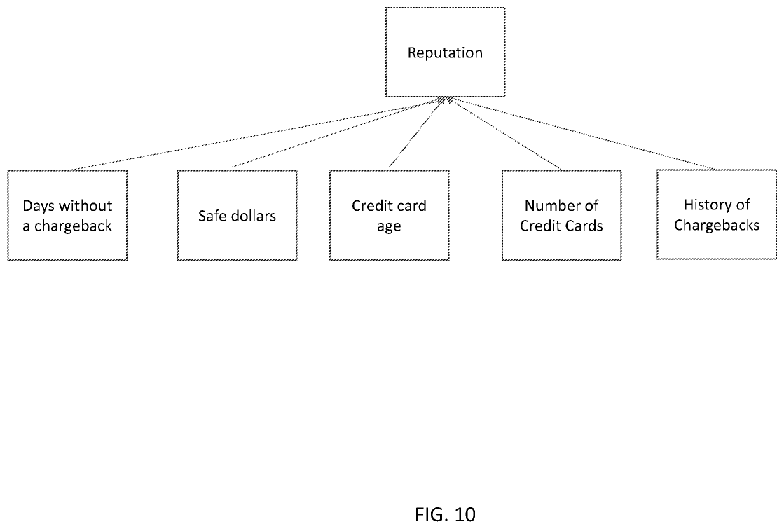

FIG. 10 shows factors considered in determining a reputation of a user identity. For example, the information sets can be used to train machine learning models to determine reputation. In some embodiments, rule based analysis is used to establish whether a user identity has a good or bad (and for example, degree) reputation. In some examples, Number of days without filing a chargeback may be considered. For example, longer periods of time without filing chargebacks may indicate that the transaction is legitimate. Other factors may include safe money used (e.g., money that cannot be filed as chargebacks), how old the credit card is being used for the transaction, the number of credit cards linked to the user, as well as a history of chargebacks.

According to some embodiments, the system may have the ability to optimize the additional authentication used to increase likelihood of authentication. In some examples, the system may balance the risk considerations (e.g., customer policy and the likelihood of authentication). According to some embodiments, merchants may also have policies/regulations they want to adhere to and so may set certain thresholds for user authentication. In some examples, the merchant may require more difficult authentication requirements for a user that has crossed a threshold of activity. For example, a merchant may typically not require verifying a phone number at sign up of an account but may require a user add one once a threshold of $2000 has been spent. Another example may include a user who is attempting to hide their location and is based in France should have multi-factor authentication (MFA) triggered. The merchant they may define their business policy and risk appetite and indirectly set thresholds and options in the system, or the system may have exposes thresholds options for merchants to set themselves directly.

As described herein the system may leverage authentication on one merchant site to affect the experience on another merchant's website (not only on future transactions on the same site). If a user registered and conducted some authentication on site A and is attempting to sign up to site B, the user would be able to enjoy the higher level of authentication without repeating the friction (authentication steps) due to the system's linking, essentially removing friction from Site B registration process. According to some examples, the user may also enjoy “continuous session/login”. Continuous session may mean a user's “logged in” session is extended without the need to log in again even after long periods of inactivity (e.g., if a user was browsing a website logged in and had to leave just before initiating checkout for a few hours, when the user comes back and checkouts, the user will not be directed to the login page for additional authentication). By cross customer federated trust the system can extend continuous login across different merchant sites leveraging probabilistic linking. The system may provide the ability to extend the session without logout/login on Site A. In addition, if a user tries to access Site B, the user may be able to login with lower level of authentication (as the probabilistic linking associates me with a successful login on Site A) and/or be able to extend their session at Site B based on learnings from activity for extending the session on Site A.

The terms “program” or “software” or “app” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that convey relationship between the fields. However, any suitable mechanism may be used to establish relationships among information in fields of a data structure, including through the use of pointers, tags or other mechanisms that establish relationships among data elements.

Also, various inventive concepts may be embodied as one or more processes, of which examples have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements.

This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed:

1. A verification system comprising:
at least one processor operatively connected to a memory, the at least one processor configured to:
determine a probabilistic linkage, in real time, between a user initiating an event at a merchant and one or more user identities associated with previous events through analysis executed on at least one of the user's attributes or attributes of the user identity;
identify, based on the probabilistic link, a user identity of the one or more user identities corresponding to the user initiating the event; and
enhance authorization or authentication decisioning for the event in response to the probabilistic linkage to at least one of a bad actor persona or a good actor persona, the authorization or authentication decisioning optionally including preventing the event in response to determining the user identity is associated with the bad actor persona or permitting the event in response to determining the user identity is associated with the good actor persona.

2. The system of claim 1, wherein the event includes at least one of an on-line transaction, on-line account sign-up, login to an existing account, a passage of a predetermined period of time after which a user session may expire, or the user's attempt to access and/or edit sensitive account information.

3. The system of claim 2, wherein the sensitive information includes at least one or phone number, payment details, and/or shipping address.

4. The system of claim 1, wherein the enhanced authorization operations executed by the at least one processor to trigger additional security measures.

5. The system of claim 4, wherein the at least one processor is configured to update the user identity in response to the user's successful navigation of additional security measures.

6. The system of claim 1, wherein the at least one processor is configured to determine a type of enhanced authorization based at least in part on attributes of the user identity and/or user attributes.

7. The system of claim 1, wherein the at least one processor is configured to determine a type of enhanced authorization based at least in part on the merchant's defined preferences for security requirement and/or confidence level.

8. The system of claim 1, wherein the at least one processor is configured to identify the user identity based on operations to analyze whether the probabilistic linkage between a user and a user identity of the one or more user identities exceeds a required level of confidence.

9. The system of claim 1, wherein the at least one processor is configured to determine the probabilistic linkage based on operations to provide the at least one of the user's attributes or attributes of the user identity to a trained model to produce the probabilistic linkage.

10. The system of claim 1, wherein the at least one processor is configured to determine the probabilistic linkage based on operations to apply a rule based system to at least one of the user's attributes or attributes of the user identity to produce the probabilistic linkage.

11. The system of claim 1, wherein each of the one or more user identities includes one or more values to establish a likelihood the user identity is associated with a bad actor persona or fraudulent activity.

12. The system of claim 11, wherein the one or more values is determined at least in part based on prior reported fraudulent behavior, characteristics independent of the user's actual identity or current registration information, purchase history, physical events, or a user identity's relation to other user identities of the one or more user identities.

13. The system of claim 12, wherein physical events include in-store transactions.

14. The system of claim 1, wherein the at least one processor is configured to prevent the event based on operations to cancel the event or transmit a command configured to cancel the event.

15. The system of claim 1, wherein the user's attributes include at least one of geographic location or position, information on the user's device, information on communication links used in the event, prior knowledge of the user's attributes or prior knowledge of the user's reputation or past authentications and authentication preferences, information independent of registration or subscription of the user to the verification system, or knowledge of the user's other on-line activities and lack of consistency.

16. The system of claim 11, wherein the at least one processor is configured to update the one or more values over time based on subsequent transactions by a related user identity.

17. The system of claim 1, wherein the at least one processor is configured to evaluate a current event, and determine an identity assurance threshold based on a probability of wrong authentication determinations.

18. The system of claim 1, wherein in response to a probability linkage that is below a predetermined threshold, the at least one processor is configured to enhance security measures, and wherein the system may obtain further attributes of the user using the enhanced security measures.

19. The system of claim 1, wherein the at least one processor is configured evaluate a required level of authentication and determine, based on prior adjustments, the minimum number of additional security measures that are required to meet threshold, and wherein the at least one processor is configured to validate the user once the minimum number of additional security measures are successfully navigated.

20. The system of claim 1, wherein the at least one processor is configured to save the attributes for future transactions, in response to determining the user identity is associated with the good actor persona, such that the same user identity is more easily authenticated at the merchant in the future.

21. The system of claim 1, wherein the at least one processor is configured to the attributes are save attributes from a current transactions for use in future transactions, in response to determining the user identity is associated with the good actor persona, such that the same user identity is more easily authenticated at a second merchant.

22. At least one non-transitory computer readable storage medium storing processor-executable instructions that, when executed by at least one processor, cause the at least one processor to perform a method for generating natural language text, the method comprising:
determining a probabilistic linkage, in real time, between a user initiating an event at a merchant and one or more user identities associated with previous events through analysis executed on at least one of the user's attributes or attributes of the user identity;
identifying, based on the probabilistic link, a user identity of the one or more user identities corresponding to the user initiating the event; and
enhancing authorization or authentication decisioning for the event in response to the probabilistic linkage to at least one of a bad actor persona or a good actor persona, the authorization or authentication decisioning optionally including preventing the event in response to determining the user identity is associated with the bad actor persona or permitting the event in response to determining the user identity is associated with the good actor persona.

23. A method of generating natural language text, the method comprising:
using at least one computer hardware processor to perform:
determining a probabilistic linkage, in real time, between a user initiating an event at a merchant and one or more user identities associated with previous events through analysis executed on at least one of the user's attributes or attributes of the user identity;
identifying, based on the probabilistic link, a user identity of the one or more user identities corresponding to the user initiating the event; and
enhancing authorization or authentication decisioning for the event in response to the probabilistic linkage to at least one of a bad actor persona or a good actor persona, the authorization or authentication decisioning optionally including preventing the event in response to determining the user identity is associated with the bad actor persona or permitting the event in response to determining the user identity is associated with the good actor persona.
